(19) United States
(12) Patent Application Publication
(10) Pub. No.: US 2026/0162024 A1
(43) Pub. Date: Jun. 11, 2026

(54) GENERATIVE ARTIFICIAL INTELLIGENCE FOR TREE-BASED MACHINE LEARNING MODEL EXPLANATIONS

(71) Applicant: SAP SE, Walldorf (DE)

(72) Inventor: Sai Sree Inavalli, Vijayawada (IN)

(21) Appl. No.: 18/977,017

(22) Filed: Dec. 11, 2024

(51) Int. Cl. G06N 20/20

(52) U.S. Cl. CPC G06N 20/20

(57) ABSTRACT

In an example embodiment, an average model prediction from predictions made by a tree-based machine learning model on training data is transformed using a sigmoid function. The sigmoid-transformed output is then used along with the numeric predictions about the training data made by the tree-based machine learning model and odds-based values generated by a tree explainer on the numeric predictions to fit a linear regressor. The fitting of the linear regressor produces coefficient and intercept values for the linear regressor, which can then be used at inference time to convert the output of the tree explainer from odds domain to the probability domain. The probability model explanations, along with the model predictions on the inference data, inference data and the average prediction in probability are passed to a generative artificial intelligence (GAI) model, which generates text-based explanations for the model predictions.

### TECHNICAL FIELD

This document generally relates to computer systems. More specifically, this document relates to use of generative artificial intelligence for tree-based machine learning model explanations.

### BACKGROUND

A large language model (LLM) refers to an artificial intelligence (AI) model that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a diagram illustrating a typical output of a tree explainer for a sample record, in accordance with an example embodiment.

FIG. 2 is a block diagram illustrating a system used to fit a linear regressor during a training stage of a tree-based machine learning model, in accordance with an example embodiment.

FIG. 3 is a block diagram illustrating a system used to generate prediction-based textual explanations, in accordance with an example embodiment.

FIG. 4 is a flow diagram illustrating a method for generating insights on output of a tree-based machine learning model, in accordance with an example embodiment.

FIG. 5 is a block diagram illustrating an architecture of software, in accordance with an example embodiment.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Enterprise data typically includes large sets of features, both numerical and categorical. Machine learning models can be used to perform various inference tasks regarding such enterprise data such as making predictions or performing classifications. A technical issue arises, however, in that the feature set may not be fixed, specifically when the enterprise data can include data of different customers with different ways of organizing and analyzing data. The result is that the encoding of categorical data in enterprise data can be very complex during data preprocessing, but that encoding is necessary in order to have the machine learning model perform properly.

One solution is to use a tree-based machine learning model, which can learn decision trees using categorical splits as well as numerical splits. Tree-based models are a type of machine learning algorithm that use a tree-like structure to make decisions based on input features. They work by splitting the data into subsets based on feature values, creating branches and nodes that lead to predictions. Examples of tree-based models include decision trees, which make decisions by splitting data at each node based on the feature that provides the best separation of the target variable and each leaf node represents a final prediction, random forests, which is an ensemble method that builds multiple decision trees and combines their predictions, helps reduce overfitting, and improves accuracy by averaging the results, and gradient boosted trees which build trees sequentially where each new tree corrects errors made by the previous ones.

The output of such tree-based models, however, are probabilities that may be difficult for human readers to understand.

One solution would be to use a tree explainer model. A tree explainer model is a tool trained to explain the output of tree-based machine learning models. An example tree explainer model is the Shapley Additive Explanations (SHAP) tree explainer.

The SHAP Tree Explainer works by calculating Shapley values for predictions made by tree-based models. Shapley values, derived from cooperative game theory, provide a fair way to distribute a total payout among players (features) based on their contributions. In this context, the “payout” is the model's prediction. For a feature i, the Shapley value φᵢ is calculated as:

$${ϕ}_{i} = {\sum }_{S ⊆ N ( i )} \frac{\vert S \vert ! \cdot ( \vert N \vert - \vert S \vert - 1 ) !}{\vert N \vert !} ( v ( S ⋃ \{ i \} ) - v ( S ) )$$

### Where:

N is the set of all features.
S is a subset of features excluding i.
v(S) is the value (or prediction) of the model with features in S.
   |S| is the number of features in subset S.

The Tree Explainer takes the structure of the decision tree (or ensemble of trees) into account. It uses the decision paths within the trees to evaluate how different features affect the output. For each feature, the SHAP tree explainer considers all possible combinations of features (subsets) to see how removing a feature changes the prediction. For each subset, it calculates the prediction difference with and without the feature in question, which gives the marginal contribution of that feature. The Shapley value for each feature is computed by averaging its marginal contributions across all possible subsets, considering the order in which features are added. The SHAP tree explainer uses specific properties of tree structures to speed up these calculations significantly, avoiding the need to evaluate all possible feature combinations explicitly. The output comprises Shapley values for each feature for a given prediction, which indicates the positive or negative contribution of each feature to that prediction.

The tree explainer is trained to quantify the effect of each feature in the input data on predictions made by the corresponding tree-based machine learning model on the input data.

These positive or negative contributions of each feature, however, are expressed in terms of odds, not probabilities. There is no current mechanism to have a tree explainer output the contributions of each feature in terms of probabilities when the input data includes unencoded categorical features.

Thus, it is desirable to have a system that is able to output the contributions of each feature of unencoded categorical data in terms of probabilities rather than odds. More specifically, while Shapley values themselves follow the additivity property (the sum of Shapley values for all features equal the difference between the prediction and a baseline value (e.g., average prediction)), the odds-based outputs of the SHAP tree explainer do not. This affects the interpretability of the tree-based model explanations.

Additionally, a user interacting with a predictive system and viewing explanation scores will not be able to easily correlate and interpret the tree-based model's behavior.

In an example embodiment, an average model prediction from predictions made by a tree-based machine learning model on training data is transformed using a sigmoid function. The sigmoid-transformed output is then used along with the numeric predictions about the training data made by the tree-based machine learning model and odds-based values generated by a tree explainer on the numeric predictions to fit a linear regressor. The fitting of the linear regressor produces coefficient and intercept values for the linear regressor, which can then be used at inference time to convert the output of the tree explainer from odds domain to the probability domain. The probability model explanations, along with the model predictions on the inference data, inference data and the average prediction in probability are passed to a generative artificial intelligence (GAI) model, which generates text-based explanations for the model predictions.

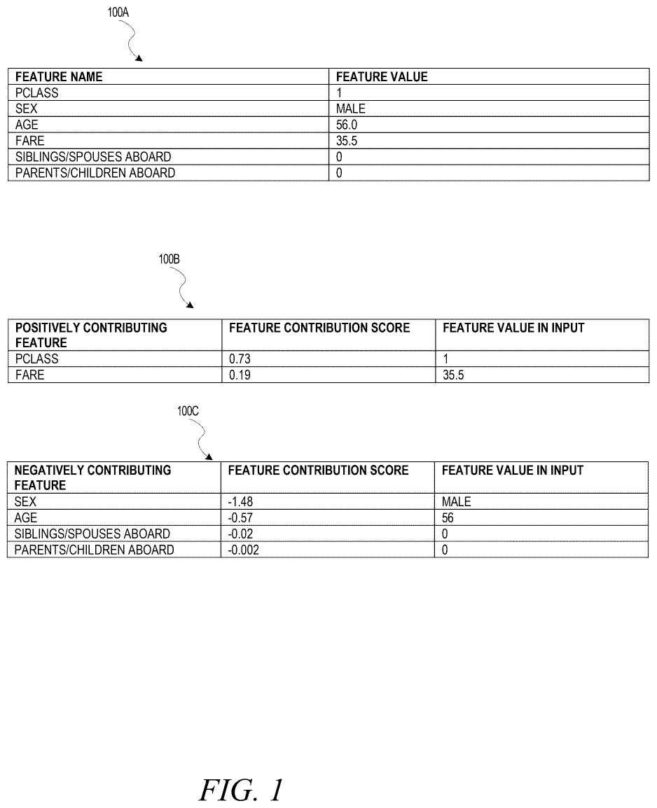

FIG. 1 is a diagram illustrating a typical output of a SHAP tree explainer for a sample record. Here, three charts 100A, 100B, 100C are output. Chart 100A describes feature names and feature values of the sample record. Chart 100B describes a feature contribution score and value for some features that positively contribute to the prediction for the sample record. Chart 100C describes a feature contribution score and value for some features that negatively contribute to the prediction for the sample record. During this process, SHAP values are computed, but the sum of the SHAP values for the sample record is −1.15 while the SHAP tree explainer expected value is −0.47. The model prediction probability is 0.16. Thus, clearly the additivity property is not being followed by the SHAP tree explainer, because −1.15 plus −0.47 does not equal 0.16.

Assuming SHAP values are s₁, s₂, s₃, . . . , sₙ, model predicted value on odds domain is pₒ, average model prediction on training dataset is eₒ, which means e is the model prediction even when no information about the features is provided. According to the additivity property of SHAP values (every value is on odds domain): s₁+s₂+s₃+ . . . +sₙ+eₒ=pₒ

Assume eₚ is the average model prediction on the training dataset in probability domain which can also be estimated by applying sigmoid on the eₒ; eₚ=sigmoid (eₒ). Model prediction in terms of probability score is pₚ. Note that the model calculated the pₚ by applying sigmoid on the pₒ. Since probability SHAP values are calculated in association with the model probability output whereas the odds SHAP are all calculated in the odds domain, simply applying sigmoid on the odds SHAP values will not produce the probability SHAP values. Hence each SHAP value is transformed from odds to probability domain sᵢ->aᵢsᵢ+bi.

$$( {a}_{1} {s}_{1} + {b}_{1} ) + ( {a}_{2} {s}_{2} + {b}_{2} ) + ( {a}_{3} {s}_{3} + {b}_{3} ) + … + ( {a}_{n} {s}_{n} + {b}_{n} ) + sigmoid ( {e}_{o} ) = {p}_{p}$$

$${a}_{1} {s}_{1} + {a}_{2} {s}_{2} + {a}_{3} {s}_{3} + … + {a}_{n} {s}_{n} + ( {b}_{1} + {b}_{2} + {b}_{3} + … + {b}_{n} ) + {e}_{p} = {p}_{p}$$

$${a}_{1} {s}_{1} + {a}_{2} {s}_{2} + {a}_{3} {s}_{3} + … + {a}_{n} {s}_{n} + B = {p}_{p} - {e}_{p}$$

$${a}_{1} {s}_{1} + {a}_{2} {s}_{2} + {a}_{3} {s}_{3} + … + {a}_{n} {s}_{n} + B = {p}_{p} - {e}_{p}$$

s₁ s₂, . . . , sₙ, pₚ, eₚ are known values. Fit a linear regressor on the above equation to get estimates of the coefficients a₁, a₂, . . . , aₙ and B.

s₁ s₂, . . . , sₙ are predictors and pₚ-eₚ is the target variable to the linear regressor.

The fitted linear regressor coefficients are a₁, a₂, . . . , aₙ and intercept is B. Redistribute the B across the SHAP value by assigning B/n to each SHAP value.

$$( {a}_{1} {s}_{1} + B / n ) + ( {a}_{2} {s}_{2} + B / n ) + ( {a}_{3} {s}_{3} + B / n ) + … + ( {a}_{n} {s}_{n} + B / n ) = {p}_{p} - {e}_{p} ( {a}_{1} {s}_{1} + B / n ) + ( {a}_{2} {s}_{2} + B / n ) + ( {a}_{3} {s}_{3} + B / n ) + … + ( {a}_{n} {s}_{n} + B / n ) + {e}_{p} = {p}_{p} {s}_{1}^{p} + {s}_{2}^{p} + {s}_{3}^{p} + … + {s}_{n}^{p} + {e}_{p} = {p}_{p}$$

s₁p, s₂p, s₃p, . . . , sₙ^{p} are the estimates for SHAP values on probability domain.

The sigmoid function takes an actual prediction in the odds domain (x) and returns 1/1+e^{-x}.

The model itself can then be constructed as follows:

### 1. Model Representation

A linear regression model predicts the dependent variable y as a linear combination of the independent variables X:

$$y = {β}_{0} + {β}_{1} {x}_{1} + {β}_{2} {x}_{2} + … + {β}_{n} {x}_{n} + ϵ$$

where:
β₀ is the intercept,
β₁, β₂, . . . , βₙ are the coefficients for each feature,
ϵ is the error term.

### 2. Cost Function

To find the best coefficients, a way to measure how well the model fits the data is provided. In an example embodiment, this is performed using a cost function, specifically the Mean Squared Error (MSE):

$$MSE = \frac{1}{m} {{\sum }_{i = 1}}^{m} {( {y}_{i} - {\hat{y}}_{i} )}^{2}$$

Where:
M is the number of observations,
yᵢ is the actual value,)
ŷᵢ is the predicted value from the model.

### 3. Optimization

The goal here is to minimize the cost function. This can be done using different optimization techniques:
Gradient Descent: This iterative method updates the coefficients in the direction that reduces the cost function:

$${β}_{j} := {β}_{j} - α \frac{\partial }{\partial {β}_{j}} MSE$$

Where α is the learning rate.
Normal Equation: For small datasets, one can directly compute the optimal coefficients using the formula:

$$β = {( {X}^{T} X )}^{- 1} {X}^{T} y$$

### 4. Model Evaluation

Once the model is fitted, its performance on the test set can be evaluated using metrics like R-squared, Adjusted R-squared, and MSE to determine how well it generalizes to new data.

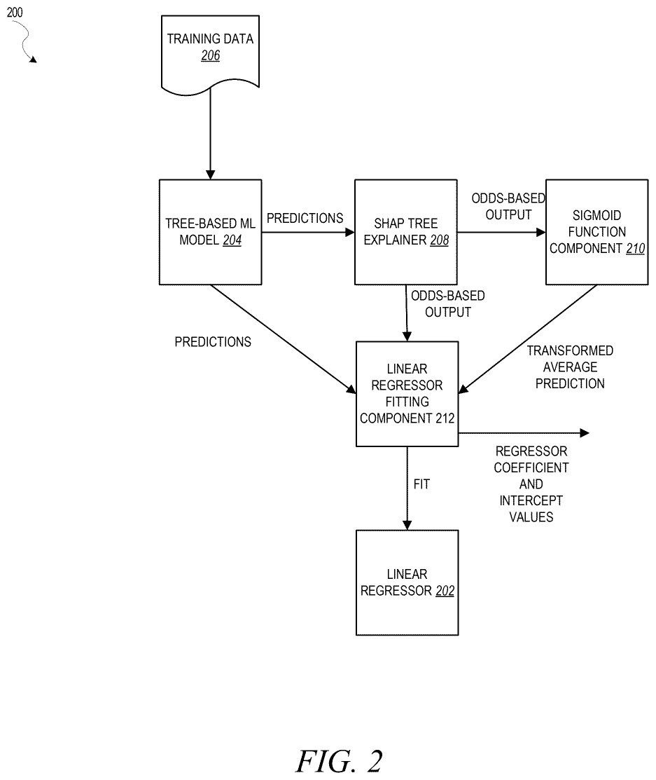

FIG. 2 is a block diagram illustrating a system 200 used to fit a linear regressor 202 during a training stage of a tree-based machine learning model 204, in accordance with an example embodiment. Here, training data 206 is passed to the tree-based machine learning model 204, which makes predictions based on the training data 206. These predictions are used to train a SHAP tree explainer 208, which generates odds-based output on the training data 206, as described previously. A sigmoid function component 210 calculates an average prediction on the predictions and performs a sigmoid function on the average prediction. The output of the sigmoid function component 210 is the sigmoid-transformed average prediction, which is passed to a linear regression fitting component 212. The linear regression fitting component 212 uses the sigmoid-transformed average prediction, the odd-based output, and the predictions to fit the linear regressor 202, which basically involves learning the regressor coefficient and intercept values.

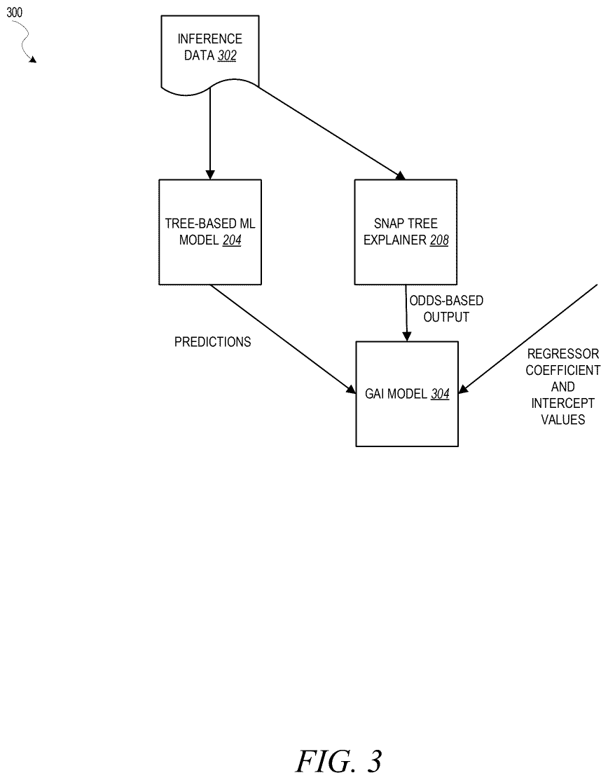

FIG. 3 is a block diagram illustrating a system 300 used to generate prediction-based textual explanations in accordance with an example embodiment. Here, inference data 302 is passed to the tree-based machine learning model 204, which makes predictions based on the inference data. Inference data in this context means any data upon which an inference (prediction) is to be made for a reason other than training the tree-based machine learning model 204 or the system 300. In other words, the inference data 302 is any data other than the training data 206 from FIG. 2.

The inference data 302 is also passed to SHAP tree explainer 208, which generates odds-based output on the inference data 302, as described previously. The odd-based output is then transformed into probability-based explanations using the coefficient and intercept of the fitted linear regressor 202. The resultant probability-based model explanations, the inference data, the model predictions on the inference data, and the transformed average prediction are passed to GAI model 304 which generates text-based explanations for the model predictions.

Large Language Models (LLMs) used to generate information are generally referred to as GAI models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of “real” or “fake” (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational Auto Encoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model, although an implementation that specifically is used with a GPT model will be described.

Below is a sample prompt that can be used to submit to the GAI to cause the generation of text-based output with insights based on the tree explainer output:

You are working with SHAP explanations to derive insights from a model's predictions. Here's how you can approach generating textual insights based on SHAP values and interactions, focusing on probability contributions:

### Expected Value and Predicted Probability:

Begin by understanding the model's expected value and the predicted probability for the given data record.

### Individual Feature Contributions:

Discuss how each feature's SHAP value contributes to the predicted probability. For example, if feature A has a SHAP value of 0.06, explain that feature A contributes positively to the probability by a certain percentage (e.g., 6%) compared to the expected value. And based on the feature name, you should try to interpret whether it is a categorical or numerical and suggest increasing or changing that field value would have increased the probability.

### Additivity of SHAP Values:

Explain how SHAP values are additive in explaining the model's prediction. If a feature's SHAP value is 0.06 and another's 0.07, together they contribute a total of 0.13 to the overall prediction compared to the expected value. The textual insights should explain what is the expected value and what is the model prediction value and the sum of all the feature SHAP values are going to be equal to the difference between the expected value and model prediction values.

### Impact of Changing Factors:

Discuss how increasing, decreasing, or changing the values of specific features might affect the model's behavior. For instance, if feature C has a negative SHAP value of −0.05, explain that decreasing feature C would increase the predicted probability by a certain percentage.

### Overall Model Behavior:

Provide a holistic view of the model's behavior for this particular data record, focusing strictly on how each feature contributes in terms of probability towards the prediction.

The input SHAP explanations is:

{
“row_id”: “01”, “prediction”: 0.104,
“TOP_POSITIVE”: (
{
“Top 1”: {
“key”: “Pclass”,
“val”: 0.0386,
“field_value”: 2,
“explanation”: “Pclass of 2 is median of the Pclass values among the survived
passengers.”
}
},
{
“Top 2”: {
“key”: “Siblings/Spouses Aboard”,
“val”: 0.003,
“field_value”: 0,
“explanation”: “Siblings/Spouses Aboard of 0 is minimum of the Siblings/Spouses
Aboard values among the survived passengers.”
}
}
),
“““
“TOP_NEGATIVE”: (
{
“Top 1”: {
“key”: “Sex”,
“val”: −0.2419,
“field_value”: “male”,
“explanation”: “27.39% of the survived passengers have Sex of value male.”}},
{
“Top 2”: {
“key”: “Age”,
“val”: −0.0746,
“field_value”: 57.0,
“explanation”: “Age of 57 is above 75% of the Age values among the survived
passengers.”}},
{
“Top 3”: {
“key”: “Fare”,
“val”: −0.0113,
“field_value”: 12.35,
“explanation”: “Fare of 12.35 is 25th percentile of the Fare values among the
survived passengers.”}},
{
“Top 5”: {
“key”: “Parents/Children Aboard”,
“val”: −0.0075,
“field_value”: 0,
“explanation”: “Parents/Children Aboard of 0 is minimum of the Parents/Children
Aboard values among the survived passengers.”}})}”””

Below is an example of text-based output of the GAI model, in accordance with an example embodiment. Here, the inference data may include data about passengers on the Titanic, and the tree-based machine learning model is attempting to evaluate the likelihood that a passenger survived the sinking of the Titanic:

### Expected Value and Predicted Probability

The model's expected value is 0.385, which means that without any additional information, the model predicts a baseline probability of 38.5%.

For this specific record, the predicted probability is 0.104 (10.4%). The SHAP values explain how the features in this record adjust the expected value to arrive at the predicted probability.

### Individual Feature Contributions (Top Positive Features)

Pclass (2) contributes positively with a SHAP value of 0.0386. This means the feature increases the predicted probability by 3.86%. In this case, having a Pclass of 2, which is the median class among survived passengers, contributes towards survival. Changing Pclass to a different value might decrease the probability.
Siblings/Spouses Aboard (0) also has a positive SHAP value of 0.003. This feature contributes 0.3% towards the predicted probability, with the field value being 0, which is the minimum value observed among the survivors. Not having any siblings or spouses aboard helps push the probability slightly upward.

### Individual Feature Contributions (Top Negative Features)

Sex (male) contributes negatively with a SHAP value of −0.2419. This means being male decreases the probability by 24.19%. Since only 27.39% of the survived passengers were male, this feature has a strong negative impact on the prediction. If the sex was female, the predicted probability would likely increase significantly.
Age (57.0) contributes negatively with a SHAP value of −0.0746, decreasing the probability by 7.46%. Being 57 years old is above the 75th percentile of the age distribution among the survived passengers, which lowers the survival chances.
Fare (12.35) also contributes negatively with a SHAP value of −0.0113. This decreases the probability by 1.13%, with the fare being in the 25th percentile, suggesting that paying a relatively low fare compared to others reduces the survival probability slightly.
Parents/Children Aboard (0) contributes negatively with a SHAP value of −0.0075, decreasing the probability by 0.75%. This feature being at its minimum (0 parents or children aboard) slightly reduces the predicted probability of survival.

### Additivity of SHAP Values

The SHAP values for all features add up to explain the difference between the model's expected value (38.5%) and the predicted probability (10.4%).

Summing all the SHAP values:
0.0386+0.003-0.2419-0.0746-0.0113-0.0075=−0.2817

This total SHAP value of −0.2817 represents the adjustment from the expected value:

$$0.385 + ( - 0.2817 ) = 0.104$$

Thus, the sum of SHAP values explains why the predicted probability is 10.4%.

### Impact of Changing Factors

Reducing the Age from 57 to a younger value (closer to the median) could increase the probability since older passengers have a lower chance of survival based on the SHAP values.
If the Sex was changed from male to female, the predicted probability would increase significantly since Sex has a strong negative SHAP value.

### Overall Model Behavior

The model predicts a 10.4% chance of survival for this particular record. The main reason for the low predicted probability is the passenger's Sex (male) and Age (57), which have the largest negative contributions.

Conversely, factors like Pclass (2) and having no siblings/spouses aboard provide slight positive contributions but are outweighed by the negative features. By understanding the interplay between these factors, we can see that the model heavily penalizes older male passengers and slightly favors those in the second class with fewer family members aboard.

Here, the SHAP values satisfy the additivity property because the SUM of the SHAP values plus the expected (average) value is close to the model's output for this prediction. Here the sum of the SHAP values is −0.234 and the expected value is 0.38. When these two values are added the result is 0.146, which is quite close to 0.16. There is a slight discrepancy due to rounding errors and the estimations of the SHAP values, but the result is still quite close.

The insight provides a clear and interpretable breakdown of how each feature influences the prediction, helping to understand the tree-based model's reasoning.

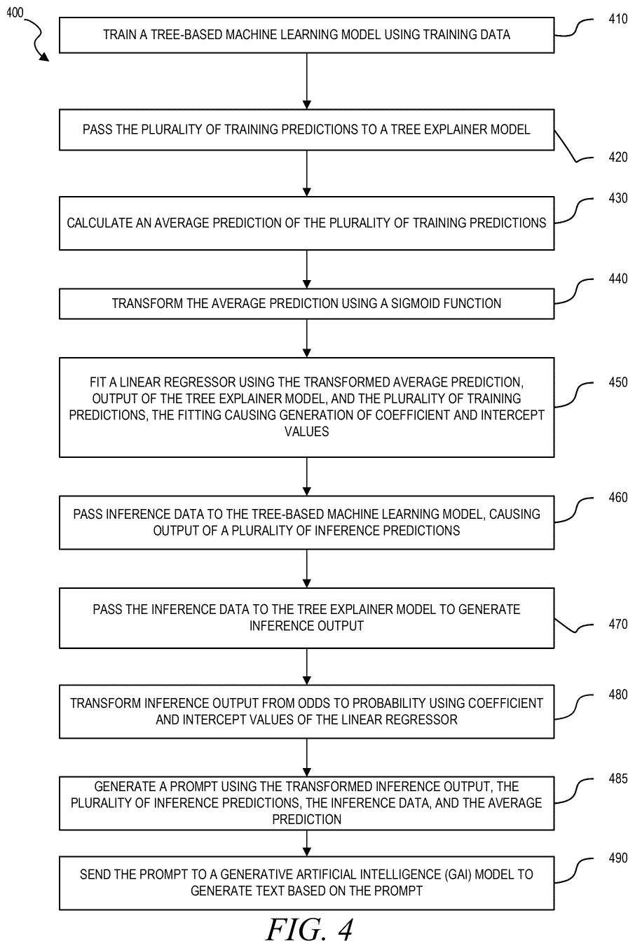

FIG. 4 is a flow diagram illustrating a method 400 for generating insights on output of a tree-based machine learning model, in accordance with an example embodiment.

At operation 410, a tree-based machine learning model is trained using training data. The training causes output of a plurality of training predictions. Thereafter, at operation 420, the plurality of training predictions are passed to a tree explainer model. This causes the tree explainer model to determine which features of the training data positively contributed to the training predictions and which features of the training data negatively contributed to the training predictions, and relative contributions that the features had to the training predictions. An average prediction of the plurality of training predictions is calculated in operation 430. As shown at operation 440, the average prediction is transformed using a sigmoid function. A linear regressor may be fitted using the transformed average prediction, output of the tree explainer model, and the plurality of training predictions (see operation 450). The fitting causes generations of coefficient and intercept values. At operation 460, inference data is passed to the tree-based machine learning model, causing output of a plurality of inference predictions. The inference data is passed, at operation 470, to the tree explainer model to generate inference output. At operation 480, the inference output is transformed from odds to probability using the coefficient and intercept values of the linear regressor. At operation 485, a prompt is generated at operation 480 using the transformed inference output, the plurality of inference predictions, the inference data, and the average prediction. The prompt is sent to a generative artificial intelligence (GAI) model to generate text based on the prompt (see operation 490).

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: training a tree-based machine learning model using training data, the training causing output of a plurality of training predictions; passing the plurality of training predictions to a tree explainer model, the tree explainer model determining which features of the training data positively contributed to the training predictions and which features of the training data negatively contributed to the training predictions, and relative contributions that the features had to the training predictions; calculating an average prediction of the plurality of training predictions; transforming the average prediction using a sigmoid function; fitting a linear regressor using the transformed average prediction, output of the tree explainer model, and the plurality of training predictions, the fitting causing generation of coefficient and intercept values; passing inference data to the tree-based machine learning model, causing output of a plurality of inference predictions; passing the inference data to the tree explainer model to generate inference output; transforming the inference output to probability form using the coefficient and intercept values; generating a prompt using the transformed inference output, the plurality of inference predictions, the inference data, and the average prediction; and sending the prompt to a generative artificial intelligence (GAI) model to generate text based on the prompt.

In Example 2, the subject matter of Example 1 includes, wherein the tree-based machine learning model is a decision tree model.

In Example 3, the subject matter of Examples 1-2 includes, wherein the tree-based machine learning model is a random forest model.

In Example 4, the subject matter of Examples 1-3 includes, wherein the tree-based machine learning model is a gradient boosted tree model.

In Example 5, the subject matter of Examples 1˜4 includes, wherein the tree explainer model is a machine learning model trained to quantify effect of each feature in input data on predictions made by the tree-based machine learning model on the input data.

In Example 6, the subject matter of Examples 1-5 includes, wherein the GAI model is an LLM.

In Example 7, the subject matter of Examples 1-6 includes, wherein the prompt further contains a system message.

Example 8 is a method comprising: training a tree-based machine learning model using training data, the training causing output of a plurality of training predictions; passing the plurality of training predictions to a tree explainer model, the tree explainer model determining which features of the training data positively contributed to the training predictions and which features of the training data negatively contributed to the training predictions, and relative contributions that the features had to the training predictions; calculating an average prediction of the plurality of training predictions; transforming the average prediction using a sigmoid function; fitting a linear regressor using the transformed average prediction, output of the tree explainer model, and the plurality of training predictions, the fitting causing generation of coefficient and intercept values; passing inference data to the tree-based machine learning model, causing output of a plurality of inference predictions; passing the inference data to the tree explainer model to generate inference output; transforming the inference output to probability form using the coefficient and intercept values; generating a prompt using the transformed inference output, the plurality of inference predictions, the inference data, and the average prediction; and sending the prompt to a generative artificial intelligence (GAI) model to generate text based on the prompt.

In Example 9, the subject matter of Example 8 includes, wherein the tree-based machine learning model is a decision tree model.

In Example 10, the subject matter of Examples 8-9 includes, wherein the tree-based machine learning model is a random forest model.

In Example 11, the subject matter of Examples 8-10 includes, wherein the tree-based machine learning model is a gradient boosted tree model.

In Example 12, the subject matter of Examples 8-11 includes, wherein the tree explainer model is a machine learning model trained to quantify effect of each feature in input data on predictions made by the tree-based machine learning model on the input data.

In Example 13, the subject matter of Examples 8-12 includes, wherein the GAI model is an LLM.

In Example 14, the subject matter of Examples 8-13 includes, wherein the prompt further contains a system message.

Example 15 is a non-transitory machine-readable medium storing instructions which, when executed by one or more processors, cause the one or more processors to perform operations comprising: training a tree-based machine learning model using training data, the training causing output of a plurality of training predictions; passing the plurality of training predictions to a tree explainer model, the tree explainer model determining which features of the training data positively contributed to the training predictions and which features of the training data negatively contributed to the training predictions, and relative contributions that the features had to the training predictions; calculating an average prediction of the plurality of training predictions; transforming the average prediction using a sigmoid function; fitting a linear regressor using the transformed average prediction, output of the tree explainer model, and the plurality of training predictions, the fitting causing generation of coefficient and intercept values; passing inference data to the tree-based machine learning model, causing output of a plurality of inference predictions; passing the inference data to the tree explainer model to generate inference output; transforming the inference output to probability form using the coefficient and intercept values; generating a prompt using the transformed inference output, the plurality of inference predictions, the inference data, and the average prediction; and sending the prompt to a generative artificial intelligence (GAI) model to generate text based on the prompt.

In Example 16, the subject matter of Example 15 includes, wherein the tree-based machine learning model is a decision tree model.

In Example 17, the subject matter of Examples 15-16 includes, wherein the tree-based machine learning model is a random forest model.

In Example 18, the subject matter of Examples 15-17 includes, wherein the tree-based machine learning model is a gradient boosted tree model.

In Example 19, the subject matter of Examples 15-18 includes, wherein the tree explainer model is a machine learning model trained to quantify effect of each feature in input data on predictions made by the tree-based machine learning model on the input data.

In Example 20, the subject matter of Examples 15-19 includes, wherein the GAI model is an LLM.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

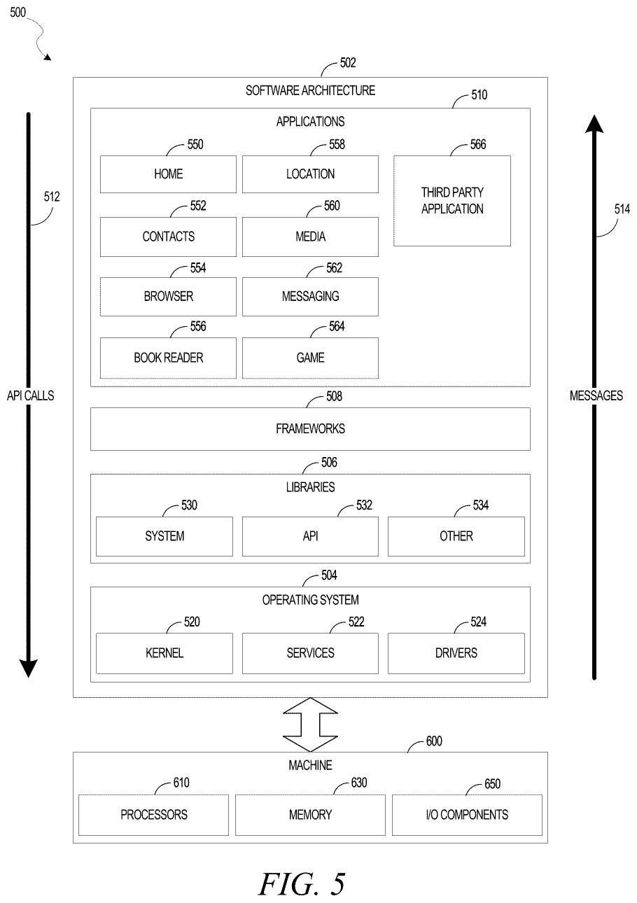

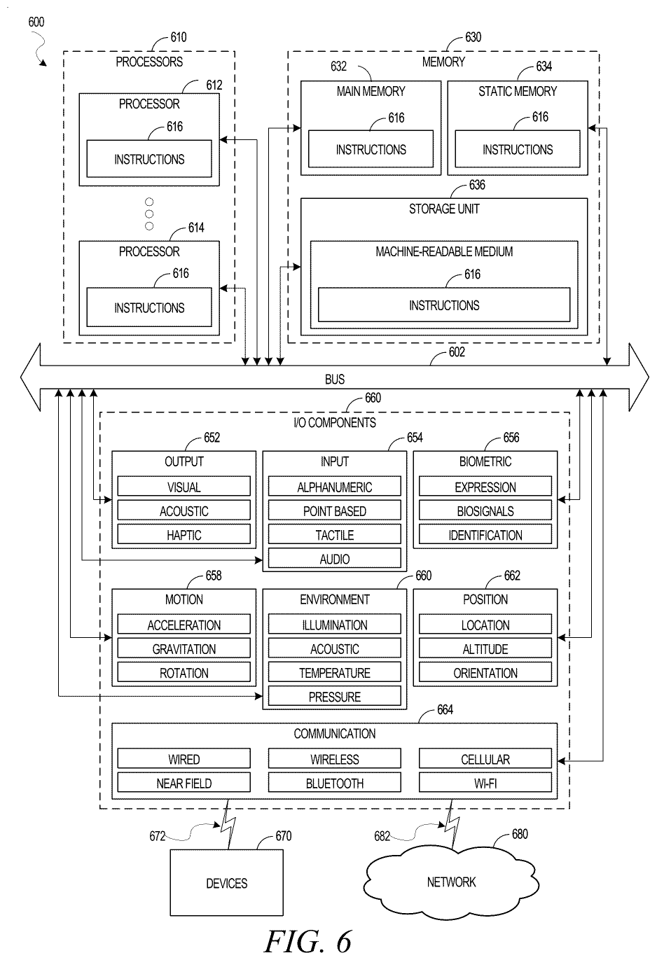

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code), for causing the machine 600 to perform any one or more of the methodologies discussed herein, may be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
training a tree-based machine learning model using training data, the training causing output of a plurality of training predictions;
passing the plurality of training predictions to a tree explainer model, the tree explainer model determining which features of the training data positively contributed to the training predictions and which features of the training data negatively contributed to the training predictions, and relative contributions that the features had to the training predictions;
calculating an average prediction of the plurality of training predictions;
transforming the average prediction using a sigmoid function;
fitting a linear regressor using the transformed average prediction, output of the tree explainer model, and the plurality of training predictions, the fitting causing generation of coefficient and intercept values;
passing inference data to the tree-based machine learning model, causing output of a plurality of inference predictions;
passing the inference data to the tree explainer model to generate inference output;
transforming the inference output to probability form using the coefficient and intercept values;
generating a prompt using the transformed inference output, the plurality of inference predictions, the inference data, and the average prediction; and
sending the prompt to a generative artificial intelligence (GAI) model to generate text based on the prompt.

2. The system of claim 1, wherein the tree-based machine learning model is a decision tree model.

3. The system of claim 1, wherein the tree-based machine learning model is a random forest model.

4. The system of claim 1, wherein the tree-based machine learning model is a gradient boosted tree model.

5. The system of claim 1, wherein the tree explainer model is a machine learning model trained to quantify effect of each feature in input data on predictions made by the tree-based machine learning model on the input data.

6. The system of claim 1, wherein the GAI model is an LLM.

7. The system of claim 1, wherein the prompt further contains a system message.

8. A method comprising:
training a tree-based machine learning model using training data, the training causing output of a plurality of training predictions;
passing the plurality of training predictions to a tree explainer model, the tree explainer model determining which features of the training data positively contributed to the training predictions and which features of the training data negatively contributed to the training predictions, and relative contributions that the features had to the training predictions;
calculating an average prediction of the plurality of training predictions;
transforming the average prediction using a sigmoid function;
fitting a linear regressor using the transformed average prediction, output of the tree explainer model, and the plurality of training predictions, the fitting causing generation of coefficient and intercept values;
passing inference data to the tree-based machine learning model, causing output of a plurality of inference predictions;
passing the inference data to the tree explainer model to generate inference output;
transforming the inference output to probability form using the coefficient and intercept values;
generating a prompt using the transformed inference output, the plurality of inference predictions, the inference data, and the average prediction; and
sending the prompt to a generative artificial intelligence (GAI) model to generate text based on the prompt.

9. The method of claim 8, wherein the tree-based machine learning model is a decision tree model.

10. The method of claim 8, wherein the tree-based machine learning model is a random forest model.

11. The method of claim 8, wherein the tree-based machine learning model is a gradient boosted tree model.

12. The method of claim 8, wherein the tree explainer model is a machine learning model trained to quantify effect of each feature in input data on predictions made by the tree-based machine learning model on the input data.

13. The method of claim 8, wherein the GAI model is an LLM.

14. The method of claim 8, wherein the prompt further contains a system message.

15. A non-transitory machine-readable medium storing instructions which, when executed by one or more processors, cause the one or more processors to perform operations comprising:
training a tree-based machine learning model using training data, the training causing output of a plurality of training predictions;
passing the plurality of training predictions to a tree explainer model, the tree explainer model determining which features of the training data positively contributed to the training predictions and which features of the training data negatively contributed to the training predictions, and relative contributions that the features had to the training predictions;
calculating an average prediction of the plurality of training predictions;
transforming the average prediction using a sigmoid function;
fitting a linear regressor using the transformed average prediction, output of the tree explainer model, and the plurality of training predictions, the fitting causing generation of coefficient and intercept values;
passing inference data to the tree-based machine learning model, causing output of a plurality of inference predictions;
passing the inference data to the tree explainer model to generate inference output;
transforming the inference output to probability form using the coefficient and intercept values;
generating a prompt using the transformed inference output, the plurality of inference predictions, the inference data, and the average prediction; and
sending the prompt to a generative artificial intelligence (GAI) model to generate text based on the prompt.

16. The non-transitory machine-readable medium of claim 15, wherein the tree-based machine learning model is a decision tree model.

17. The non-transitory machine-readable medium of claim 15, wherein the tree-based machine learning model is a random forest model.

18. The non-transitory machine-readable medium of claim 15, wherein the tree-based machine learning model is a gradient boosted tree model.

19. The non-transitory machine-readable medium of claim 15, wherein the tree explainer model is a machine learning model trained to quantify effect of each feature in input data on predictions made by the tree-based machine learning model on the input data.

20. The non-transitory machine-readable medium of claim 15, wherein the GAI model is an LLM.
